(19) United States
(12) Patent Application Publication
(10) Pub. No.: US 2004/0253988 A1
(43) Pub. Date: Dec. 16, 2004

(54) Cellular telephone having data card reader and method for dialing responsively

(76) Inventor: Jon S. Goldman, Riverside, CA (US)

Correspondence Address: Karl M. Steins, Steins & Associates, Suite 120, 2333 Camino del Rio South, San Diego, CA, 92108, US

(21) Appl. No.: 10/463,304

(22) Filed: Jun. 16, 2003

(51) Int. Cl. H04M 1/00; H04B 1/38

(52) U.S. Cl. 455/564; 455/558

(57) ABSTRACT

A Cellular Telephone Having Data Card Reader and Method for Dialing Responsively is disclosed. The device and method is configured to interact with an “automated business card” such that when the card is swiped or otherwise read by the cellular telephone, the telephone will responsively dial a telephone number stored on the card. The device and method further is capable of optional information also storable on the automated business card such that the telephone will be able to use the optional information to dial other numbers after the initial connection is established. Furthermore the devices and system enable the telephone and telephony system to obtain payment/billing information from the automated business card once a connection has been established.

### BACKGROUND OF THE INVENTION

1. Field of the Invention

This invention relates generally to telephony and, more specifically, to a Cellular Telephone Having Data Card Reader and Method for Dialing Responsively

2. Description of Related Art

Cellular telephones have become a mainstay of the modern lifestyle. In fact, in many countries of the world, individuals have ceased to subscribe to conventional wired telephone service to their residences. In the course of this cellular telephone evolution, many different features and functions have been added to the telephones. Once functional feature of particular pertinence to the present invention is that of a combination cellular telephone and credit card reading device. FIG. 1 depicts the functionality of one embodiment of these prior devices.

FIG. 1 is a flow diagram depicting a prior art cellular telephone activation process 100. This particular process 100 is described in Phillips et al, U.S. Pat. No. 5,870,459. The Phillips device is a recyclable cellular telephone that can be purchased having prepaid connection time stored within it. Once the user has exhausted the telephone's prepurchased minutes or the telephone's time-based registration has expired (or nearly expired), the user can dispose of the telephone in a specified recycling receptacle. Alternatively, he or she can swipe his or her credit card through the magnetic card reader that is incorporated into the telephone, and thereby pay for extended usage.

As shown in FIG. 1, the activation (or extension) process 100 commences with the user obtaining the telephone 102. When desired, the user then swipes a credit card 104. The telephone transmits the swiped digital payment data through the cellular system to the appropriate electronic payment processing center. Next, the account issuer (i.e. of the credit card) authorizes the requested charge 106, and this authorization data is sent back to the phone set 108 and stored therein. The telephone actually has a small printer incorporated within it; this printer prints a receipt for the charge to the credit card 110, and a new directory telephone number is also then printed 112 (since the telephone number may change to another number in the pool of available numbers for these recyclable telephones). The user is then free to use the telephone to make calls in accordance with the registered time or call time authorization 114. When the registration time expires or nearly expires 116, the process can be repeated. Another prior device having a somewhat similar purpose and functionality is depicted in FIGS. 2A and 2B.

FIGS. 2A and 2B are exploded side and front views, respectively, of a prior art credit card operated cellular telephone 60. This particular device is disclosed in Bailey, U.S. Pat. No. 5,729,591. The Bailey device, as depicted in FIG. 2A is a combination of subassemblies, namely, a conventional cellular telephone 62, an interface assembly 64, and a battery pack 66. The interface assembly 64 is configured to slide into the area in the back of the telephone 62 where the battery pack 66 would normally attach; the battery pack 66 then “piggy backs” onto a socket on the back of the interface assembly 64.

As shown from the front in FIG. 2B, the interface assembly 64 has a card swiping slot 68 protruding from its side that enables the user to swipe his or her card through it. The operation of the Bailey device is very similar to the Phillips device, namely, it is provided to permit the user to add talk time to their cellular telephone using a credit card; there is no other disclosed functionality for these devices.

### SUMMARY OF THE INVENTION

In light of the aforementioned problems associated with the prior devices and methods, it is an object of the present invention to provide a Cellular Telephone Having Data Card Reader and Method for Dialing Responsively. The device and method should interact with an “automated business card” such that when the card is swiped or otherwise read by the cellular telephone, the telephone will responsively dial a telephone number stored on the card. The device and method should further be capable of optional information also storable on the automated business card such that the telephone will be able to use the optional information to dial other numbers after the initial connection is established. It is a further object that the devices and system enable the telephone and telephony system to obtain payment/billing information from the automated business card once a connection has been established.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a flow diagram depicting a prior art cellular telephone activation process;

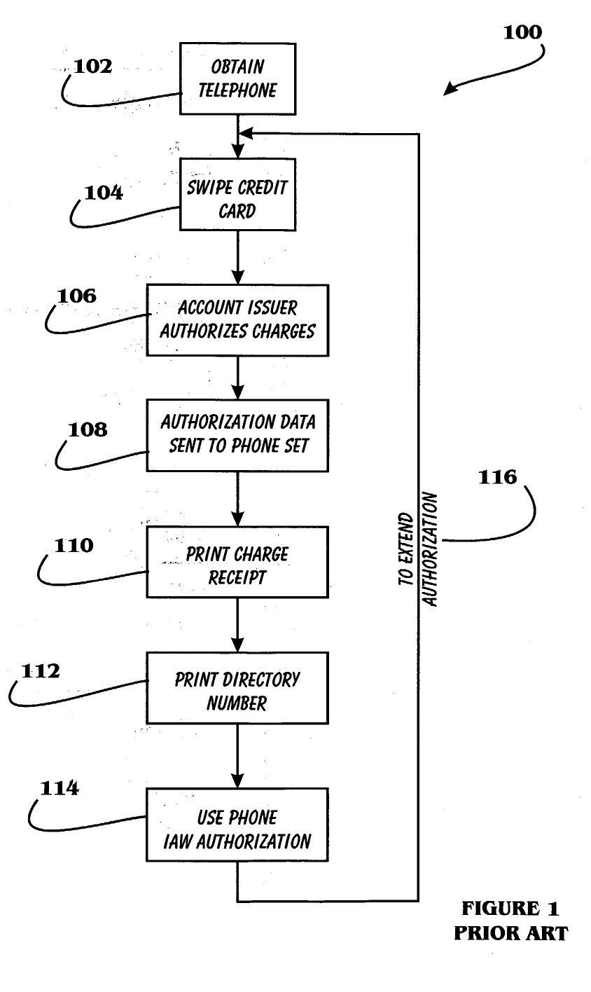

FIGS. 2A and 2B are exploded side and front views, respectively, of a prior art credit card operated cellular telephone;

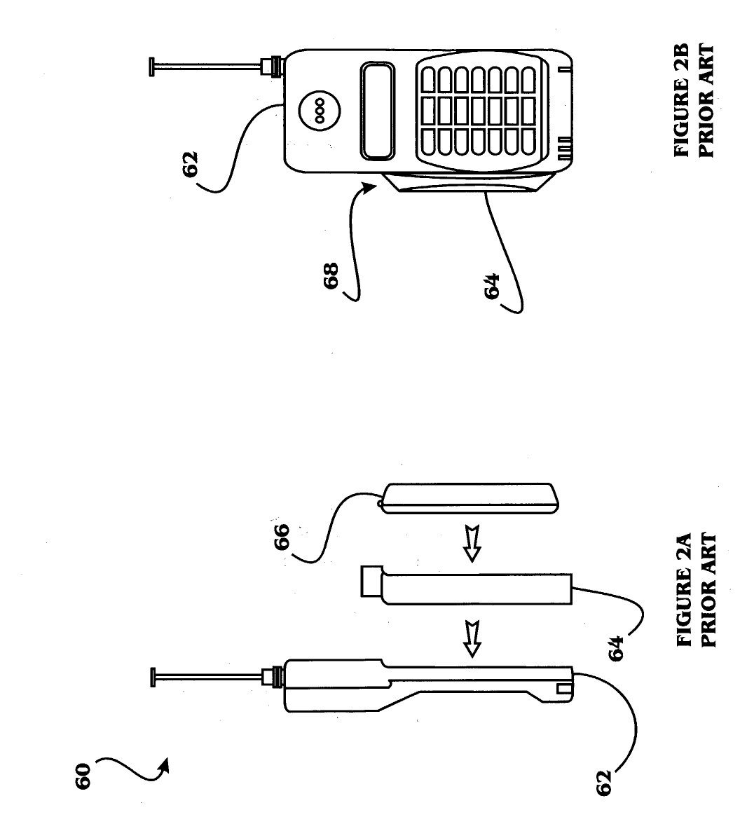

FIGS. 3A and 3B are front and back views of a conventional business card;

FIGS. 4A and 4B are front and back views of an automated business card of the present invention;

FIG. 5 is a back view of the business card of FIG. 4;

FIG. 6 is a flow diagram depicting a preferred automatic dialing process of the present invention;

FIG. 7 is a flow diagram depicting a preferred automatic payment process of the present invention;

FIG. 8 is a preferred embodiment of an automated cellular telephone of the present invention; and

FIG. 9 is a block diagram depicting the functionality of the interface module and telephone of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Cellular Telephone Having Data Card Reader and Method for Dialing Responsively.

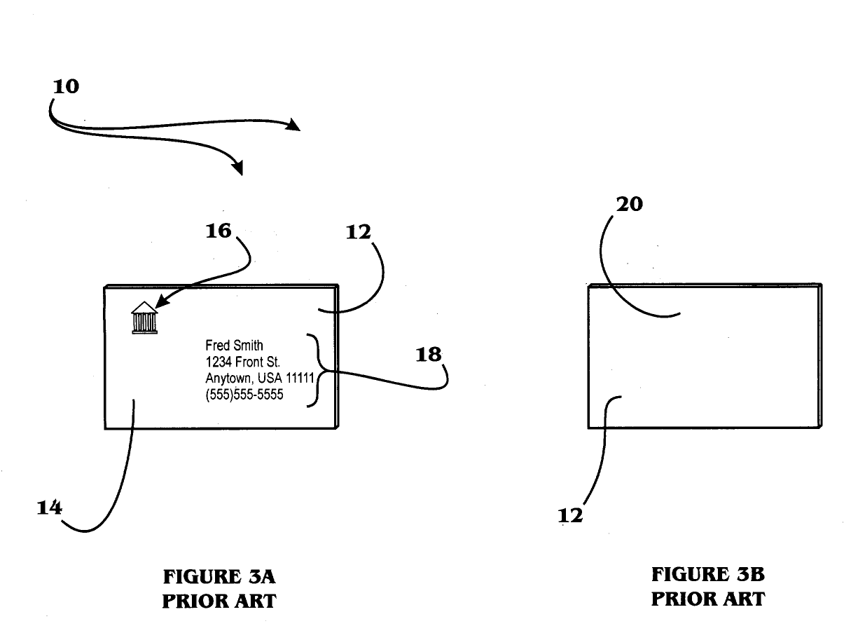

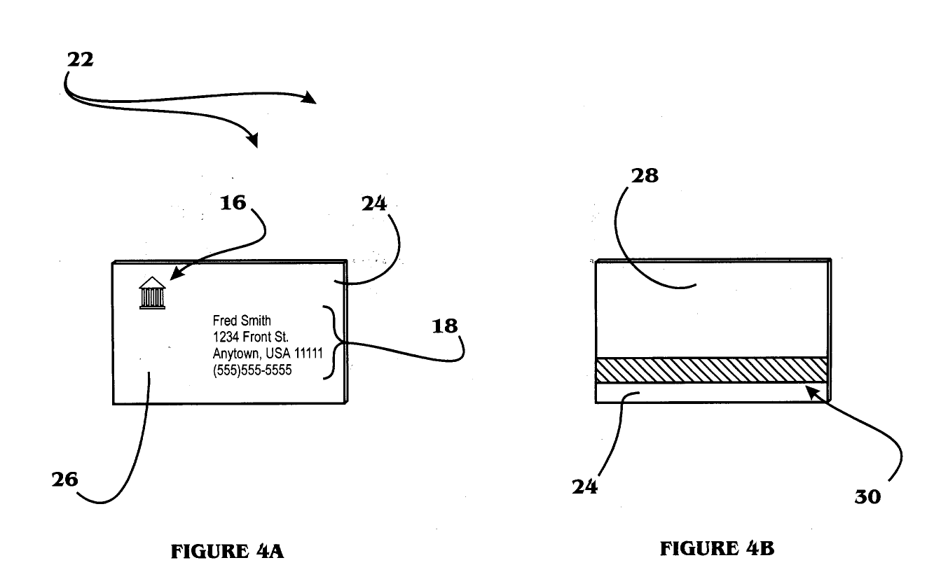

The present invention can best be understood by initial consideration of FIGS. 3A and 3B. FIGS. 3A and 3B are front and back views of a conventional business card 10. As is well-known, the conventional'business card 10 is made from a card stock substrate 12 that is defined by a front face 14 and a rear face 20. The front face 14 typically has a logo or other company indicia 16 inscribed on it, as well as the contact information indicia 18 for the person to whom the business card 10 belongs. As shown, the contact information indicia 18 includes the owner's name, address and telephone number at a minimum. There is typically nothing inscribed on the rear face 20 of the conventional business card 10. Turning to FIGS. 4A and 4B, we can begin to understand the invention of the present invention.

FIGS. 4A and 4B are front and back views of an automated business card 22 of the present invention. As with the conventional card, the automated business card 22 comprises a substrate 24 defined by a front fact 26 and a rear face 28. The substrate 24 may or may not be from paper or other card stock material; it may alternatively be from plastic or plasticized material for durability purposes.

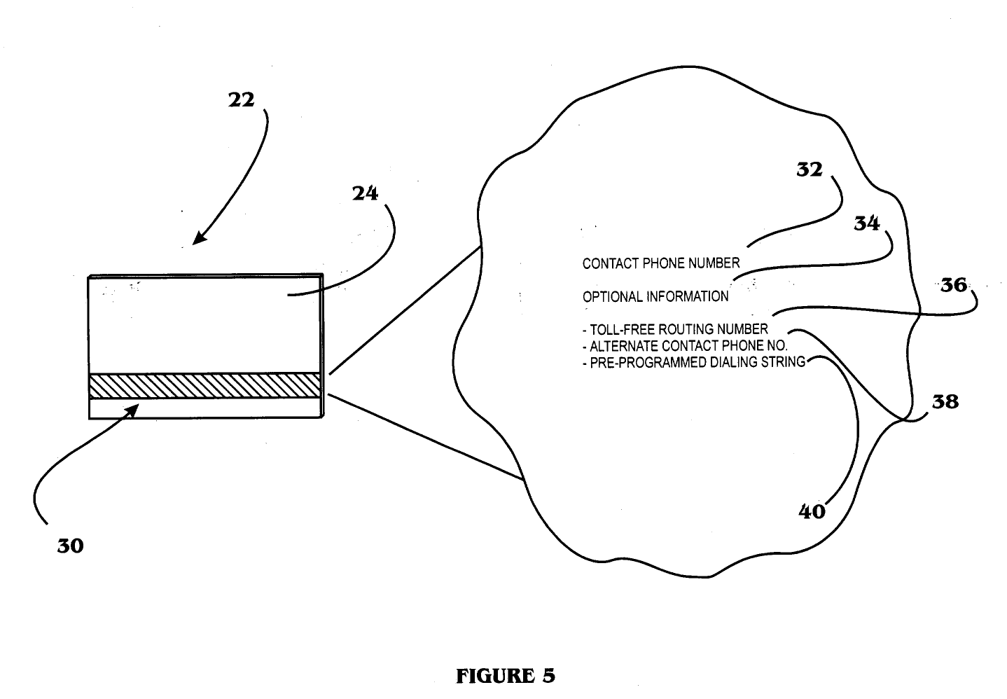

As with the conventional card, the automated business card 22 has company indicia 16 and contact information indicia 18 inscribed on its front face 26; what is unique is that there is a magnetic stripe 30 attached, incorporated or otherwise displayed on the back face 28. The magnetic stripe 30 is a storage repository for digital data, as will be described more fully below in connection with FIG. 5.

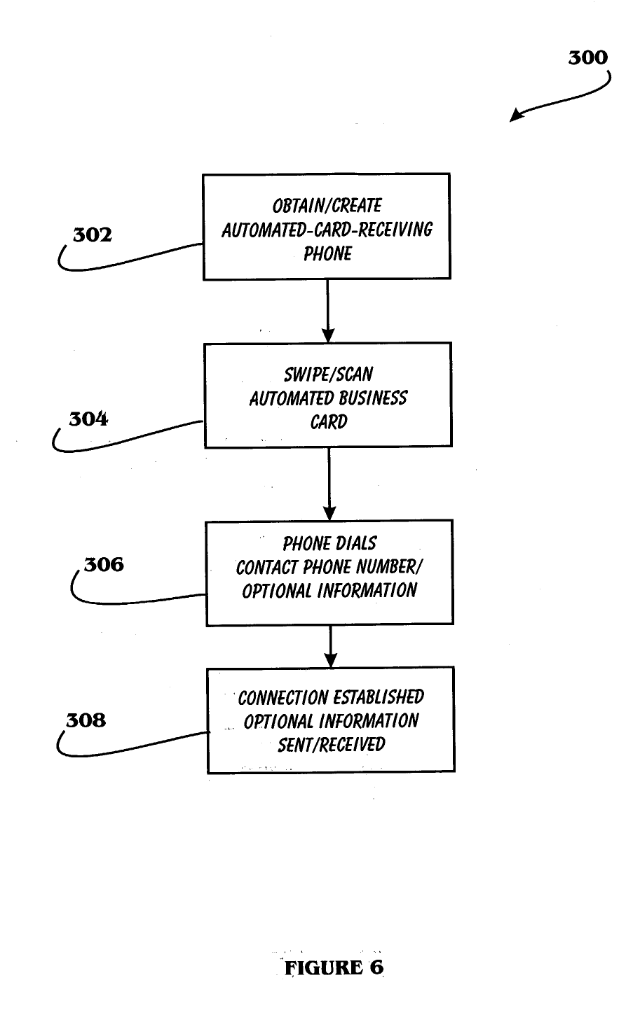

FIG. 5 is a back view of the business card 22 of FIG. 4. In digital form, a plurality of contact information may be stored within the magnetic stripe 30. The contact telephone number 32 and/or other optional information 34 may be stored therein. In some cases, the optional information 34 may be a toll-free routing telephone number 36—this would direct the telephone to dial a toll-free number, after which a pre-programmed dialing string 40 would be dialed, which would direct the system to connect the caller to the contact's phone number. Alternatively, the stripe 30 could have one or more alternate contact telephone numbers 38, such that the contact could be contacted at alternate numbers (or alternate persons could be contacted in cases of unavailability of the primary contact). Other optional information may be discount information; the card may transmit a particular discount code during the call that gives an automatic discount as well as a record of the source of and/or reason for the discount. Any or all of these data sets may be stored on any one card 22, depending upon the system configuration. It should also be understood that the storage media is shown here as being a magnetic stripe 30 attached to the rear face of the card 22; in other embodiments, it may be a “smart chip” embedded within the card 22, as well as may be located elsewhere on or within the substrate 24. Now turning to FIG. 6, we can examine how the card 22 interfaces with the other components of the present invention.

FIG. 6 is a flow diagram depicting a preferred automatic dialing process 300 of the present invention. Of course, the process 300 begins with the user obtaining an automated-card-receiving (or enabled) telephone 302. This might be accomplished by acquiring a telephone with the necessary hardware built into it, or it might be created by adding a module containing the card processing hardware and software to a conventional cellular telephone (perhaps similar to the Bailey device discussed above).

Next, the user swipes or scans the desired automated business card 304 through the enabled telephone. When we talk about swiping herein, we mean any type of reading of digital data from the card, including Infrared, RF, HF and other technologies. In response, the telephone automatically dials the contact telephone number and/or optional information 306 contained within the storage medium on the automated business card. The next event is that the connection is established and/or the optional information is sent and received by the network 308.

In layperson's terms, then, the cardowner of the automated business card distributes business cards with his or her telephone number displayed on its front as well as stored in digital form in the storage media. Any of the distributees need simply swipe the card through their enabled cellular telephone, and the telephone immediately dials the cardowner's telephone number (either directly or through the toll-free routing system previously discussed).

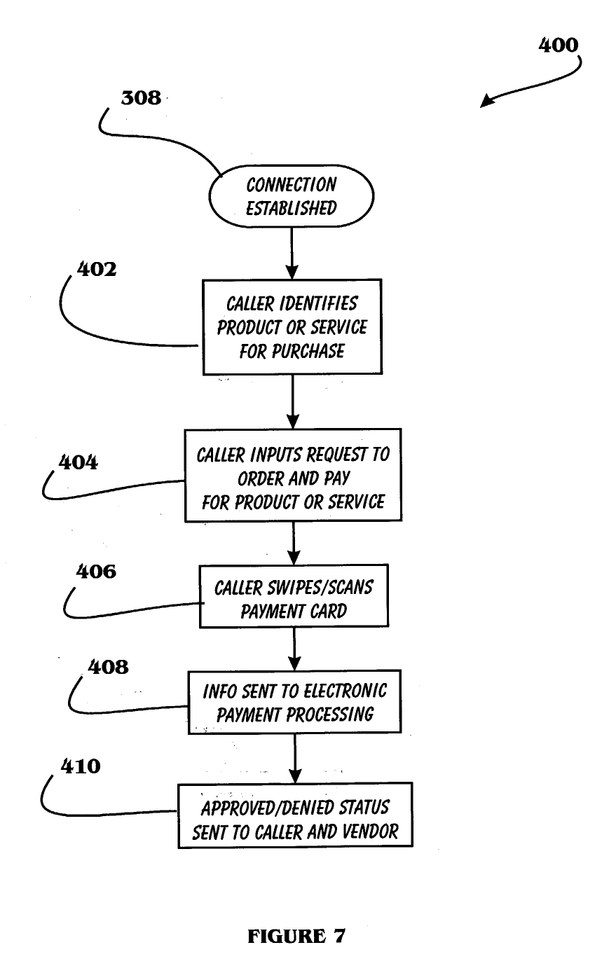

This system could be expanded to applications other than business cards, such a manufacturer's coupons, hospital emergency numbers (e.g. for medical I.D. tags), or numerous other applications. For example, a national pizza chain could sell prepaid cards that not only have “pizza bucks” that can be used to purchase pizza, but also has the automatic dialing feature to enable the user to use the autodial feature previously described. FIG. 7 depicts yet another application for the present invention.

FIG. 7 is a flow diagram depicting a preferred automatic payment process 400 of the present invention. This process 400 enables the user (once connected via their automated business card) to actually pay for products or services while connected to a vendor. While the connection is established with the vendor 308, the caller first identifies (i.e. is offered) a product or service that he or she wishes to purchase 402. The caller, either by voice prompt or by pushing specified buttons on the handset of the telephone, inputs a purchase request 404. Next, the caller swipes or scans their payment card 406; the telephone responsively transmits the payment information to the electronic payment processing operation 408. The electronic payment processing system/operation will then transmit the approved or denied charge to the caller and the vendor of the product or service 410. In a non-depicted embodiment, the device of the present invention may include a printer to print a receipt for purchased goods or services. Alternatively, the device may store purchase receipts for later printing or otherwise transferring to another computing device for review/recordkeeping.

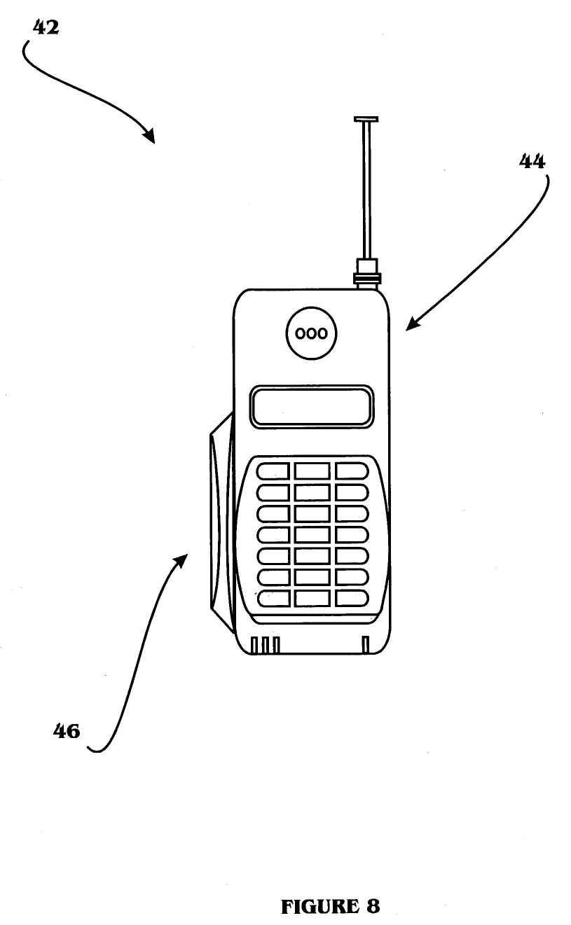

In yet another alternate, the owner of the automated business cards could actually incorporate payment information along with their contact information, such as to actually pay for the phone call. In this case, the process would essentially combine the processes of FIGS. 6 and 7 into a single process commencing with a single swipe of the card. FIG. 8 depicts one possible form for the telephone of the present invention.

FIG. 8 is a preferred embodiment of an automated cellular telephone 42 of the present invention. As shown, and as discussed above, the automated cellular telephone 42 may be in a very similar hardware form as the Bailey device, namely having a cellular telephone 44 and a module for scanning or swiping a card therethrough. In this embodiment, the module 46 is a “dual mode” interface module that enables the user to swipe either an automated business card or payment card. In other words, the interface module 46 has the necessary hardware and software incorporated within it to not only read these two types of cards, but to also direct the cellular telephone 44 to execute the appropriate actions automatically in response. The phone may also have “shortcut” buttons located or otherwise programmed, such as “pay,” “balance request,” and “enter PIN” buttons or functions. Furthermore, the telephone/attachment may be capable of saving/storing the scanned information for future use so that re-scanning of the card won't be necessary.

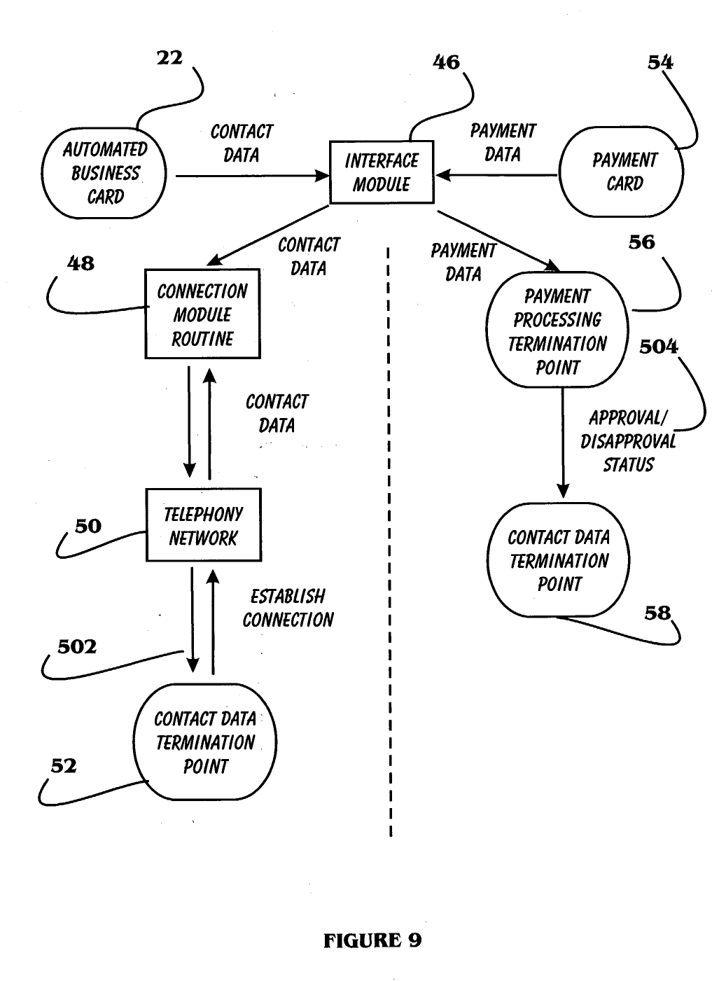

It should be understood that in other versions, a Personal Digital Assistant (either with a integrated telephone or with the ability to trigger a telephone to dial a swiped number) may be used interchangably with the cellular telephone 44 functionality as described herein. Furthermore, the term “cellular” refers to any type of telephone set, including a cordless phone and other wireless technologies, including satellite communications. Finally turning to FIG. 9, we can examine how the swiping of the two card result in different events occurring.

FIG. 9 is a block diagram depicting the functionality of the interface module and telephone of the present invention. On the left, we see that the swiping of an automated business card 22 transfers the contact data (and/or optional data) to the interface module 46. the interface module 46 directs the connection module/routine (e.g. software) 48 within the interface module or telephone to use the contact data and interface with the telephony network 50 to make the telephone call and then establish the connection 502 with the termination point for the contact data 52. As discussed above, this could be a direct call or it could be through a toll-free routing system (or to an alternate telephone number).

If a payment card 54 is scanned into the interface module 46, the payment data is transferred thereto, where it is transmitted to a payment processing termination point 56 (through the telephony system); the approval/disapproval status 504 is then sent to the contact data termination point 58 (i.e. the automated business cardowner's contact telephone number).

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A method for operating a telephone, comprising the steps of:
obtaining an automated business card;
transferring data from said automated business card to a automated card enabled telephone device; and
said telephone device automatically establishes a communications connection to a caller responsive to said transferred data.

2. The method of claim 1, wherein said obtaining step comprises obtaining an automated business card having digital data stored thereon.

3. The method of claim 2, wherein said digital data of said automated business card of said obtaining step further comprises a contact phone number.

4. The method of claim 3, wherein said communications connection step comprises said telephone automatically establishing a connection to said contact phone number.

5. The method of claim 4, wherein said automated business card of said obtaining step is further defined by a front face and a rear face, said front face further including contact information indicia displayed thereon, said contact information indicia comprising said contact phone number.

6. The method of claim 5, wherein:
said automated business card of said obtaining step further comprises a digital data repository therein; and
said transferring data step comprises said telephone device wirelessly reading said digital data from said repository on said automated business card.

7. The method of claim 6, wherein:
said digital data repository of said automated business card of said obtaining step comprises a magnetic stripe attached to a surface of said business card; and
said transferring step comprises a user swiping said automated business card through a magnetic card reader contained in said telephone device, whereby said digital data is transferred to said telephone device.

8. The method of claim 7, wherein said magnetic card reader of said telephone device of said transferring step is a dual mode card reader having the capability to read magnetic stripes on said automated business cards as well as on payment cards.

9. An automated business card comprising:
a substrate defined by a front face;
contact information indicia displayed on said front face; and
a data repository associated with said substrate containing data representing said contact information indicia in digital form.

10. The business card of claim 9, wherein:
said contact information indicia further comprises a contact telephone number; and
said data repository contains said contact telephone number in digital form.

11. The business card of claim 10, wherein said data repository further contains optional information in digital form, said optional information comprising a toll-free routing telephone number.

12. The business card of claim 11, wherein said optional information further comprises at least one optional telephone number in digital form.

13. The business card of claim 12, wherein said optional information further comprises pre-programmed dialing string data in digital form.

14. An automated cellular telephone, comprising:
an interface module comprising a digital data reader; and
a connection module/routine is configured to dial a telephone number responsive to data read by said digital data reader.

15. The telephone of claim 14, wherein said interface module is configured to read contact data in digital form from an automated business card.

16. The telephone of claim 15, wherein said connection module/routine is configured to dial said read contact data.

17. The telephone of claim 16, wherein said interface module is further configured to read payment data in digital form from a payment card.

18. The telephone of claim 17, wherein said interface module is further configured to read optional data in digital form from said automated business card.
